(19) United States
(12) Patent Application Publication
(10) Pub. No.: US 2026/0310029 A1
(43) Pub. Date: Oct. 8, 2026

(54) ELECTRO-OPTICAL DEVICE AND ELECTRONIC APPARATUS

(71) Applicant: SEIKO EPSON CORPORATION, Tokyo (JP)

(72) Inventors: Tomoya TAKEUCHI, CHITOSE-SHI (JP); Daisuke MIYAWAKI, CHITOSE-SHI (JP)

(73) Assignee: SEIKO EPSON CORPORATION, Tokyo (JP)

(21) Appl. No.: 19/635,797

(22) Filed: Apr. 1, 2026

(30) Foreign Application Priority Data
Apr. 3, 2025 (JP) 2025-061720

(51) Int. Cl. G02F 1/1362; G02F 1/1368; G03B 21/00

(52) U.S. Cl. CPC G02F 1/136213; G02F 1/1368; G03B 21/006

(57) ABSTRACT

An electro-optical device includes a conductive layer including, in a layer between a transistor and a pixel electrode, a first conductive film formed of a material having light reflectivity, and a second conductive film formed of a material lower in optical reflectance than the first conductive film and disposed closer to the transistor than the first conductive film. The conductive layer includes a main body portion having a projecting portion projecting to a corner portion of an opening region of a pixel, an extending portion, and another extending portion, and in at least the projecting portion, the first conductive film has an opening, and the second conductive film of the conductive layer is electrically coupled to the pixel electrode via a contact hole disposed inside the opening of the first conductive film at a position separated from an edge of the opening in a plan view.

The present application is based on, and claims priority from JP Application Serial Number 2025-061720, filed April 3, 2025, the disclosure of which is hereby incorporated by reference herein in its entirety.

### BACKGROUND

### 1. Technical Field

The present disclosure relates to an electro-optical device and an electronic apparatus including the electro-optical device.

### 2. Related Art

An electro-optical device described in, for example, JP-A-2019-78825 is known as a related-art electro-optical device.

JP-A-2019-78825 describes a liquid crystal panel including capacitive elements each coupled via a pixel contact hole directly below a pixel electrode.

JP-A-2019-78825 is an example of the related art.

In the electro-optical device described in JP-A-2019-78825, a capacitance electrode constituting the capacitive element is formed of titanium nitride. Since the reflectance of titanium nitride is low, most of light incident on the capacitance electrode is not reflected but is absorbed, which causes a rise in temperature of the liquid crystal panel.

### SUMMARY

An electro-optical device according to an aspect of the present application includes: a transistor; a pixel electrode disposed at a light incident side of the transistor; and a first conductive layer including, in a layer between the transistor and the pixel electrode, a first film formed of a material having light reflectivity, and a second film formed of a material lower in optical reflectance than the first film and disposed closer to the transistor than the first film, wherein the first conductive layer includes a main body portion having a projecting portion projecting to a corner portion of an opening region of a pixel, a first extending portion extending from the main body portion along a first direction, and a second extending portion extending from the main body portion along a second direction crossing the first direction, and in at least the projecting portion of the main body portion of the first conductive layer, the first film of the first conductive layer has an opening, and the second film of the first conductive layer is electrically coupled to the pixel electrode via a contact hole disposed inside the opening of the first film at a position separated from an edge of the opening in a plan view.

An electronic apparatus according to an aspect of the present application includes the electro-optical device described above.

### BRIEF DESCRIPTION OF THE DRAWINGS

FIG. 1 is a plan view of an electro-optical device according to Embodiment 1.

FIG. 2 is a cross-sectional view of the electro-optical device taken along a line II-II in FIG. 1.

FIG. 3 is an equivalent circuit diagram showing an electrical configuration of an element substrate.

FIG. 4 is a diagram schematically illustrating a cross-sectional structure and a coupling relationship of a display region of the element substrate.

FIG. 5 is a diagram illustrating a planar structure of the display region of the element substrate.

FIG. 6 is a diagram illustrating the planar structure of the display region of the element substrate.

FIG. 7 is a diagram illustrating the planar structure of the display region of the element substrate.

FIG. 8 is a diagram illustrating the planar structure of the display region of the element substrate.

FIG. 9 is a diagram illustrating the planar structure of the display region of the element substrate.

FIG. 10 is a diagram illustrating the planar structure of the display region of the element substrate.

FIG. 11 is a diagram illustrating the planar structure of the display region of the element substrate.

FIG. 12 is a cross-sectional view taken along a line A-A in FIG. 11.

FIG. 13 is a cross-sectional view taken along a line B-B in FIG. 11.

FIG. 14 is a flowchart showing a manufacturing process of a capacitive element and a pixel contact.

FIG. 15 is a cross-sectional view showing an aspect of the manufacturing process.

FIG. 16 is a cross-sectional view showing an aspect of the manufacturing process.

FIG. 17 is a cross-sectional view showing an aspect of the manufacturing process.

FIG. 18 is a cross-sectional view showing an aspect of the manufacturing process.

FIG. 19 is a cross-sectional view showing an aspect of the manufacturing process.

FIG. 20 is a plan view showing an aspect of the manufacturing process.

FIG. 21 is a perspective view illustrating an example of an electronic apparatus according to Embodiment 2.

### DESCRIPTION OF EMBODIMENTS

Some embodiments of the present disclosure will hereinafter be described with reference to the drawings.

Note that in the drawings described below, elements may be illustrated at different dimensional scales in accordance with the elements in some cases in order to make the elements eye-friendly.

The description will hereinafter be presented using an X axis, a Y axis, and a Z axis orthogonal to each other as appropriate for the sake of convenience of the explanation. Further, one of directions along the X axis is described as an X1 direction, and a direction opposite to the X1 direction is described as an X2 direction. Similarly, one of directions along the Y axis is described as a Y1 direction, and a direction opposite to the Y1 direction is described as a Y2 direction. One of directions along the Z axis is described as a Z1 direction, and a direction opposite to the Z1 direction is described as a Z2 direction. Hereinafter, viewing in the Z1 direction or the Z2 direction is referred to as "plan view," and viewing in a direction perpendicular to a cross section including the Z axis is referred to as "cross-sectional view."

In the following description, for example, with respect to a substrate, the description "on a substrate" represents any one of when something is disposed in contact with the substrate, when something is disposed above the substrate with another structure intervening therebetween, and when something is disposed so that a part thereof is in contact with the substrate and another part thereof is located above the substrate with another structure intervening therebetween. Further, for example, with respect to the substrate, a description of an "upper surface of the substrate" represents a surface at the Z1 direction side of the substrate, and a description of a "lower surface of the substrate" represents a surface at the Z2 direction side of the substrate.

### 1. Embodiment 1

In the present embodiment, a liquid crystal device 300 will be described as an example of an electro-optical device.

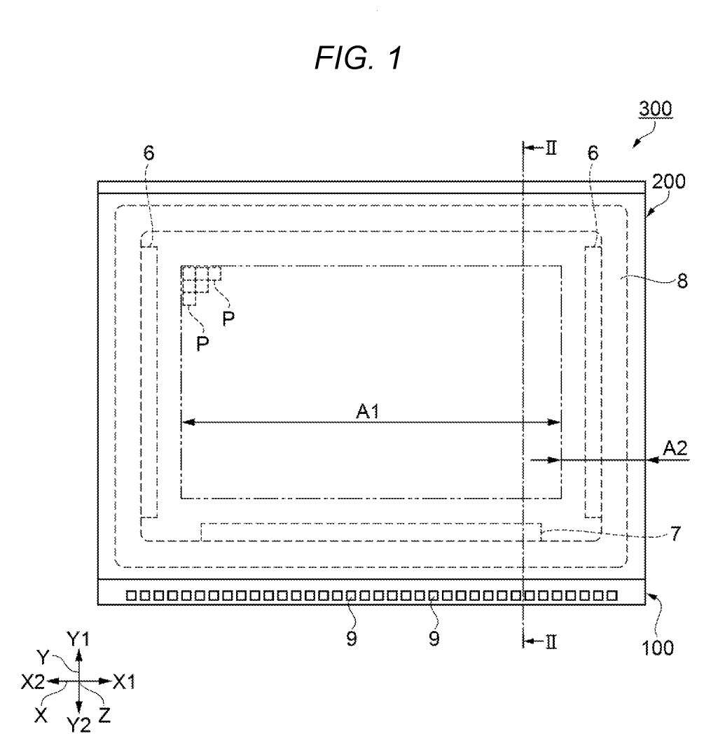

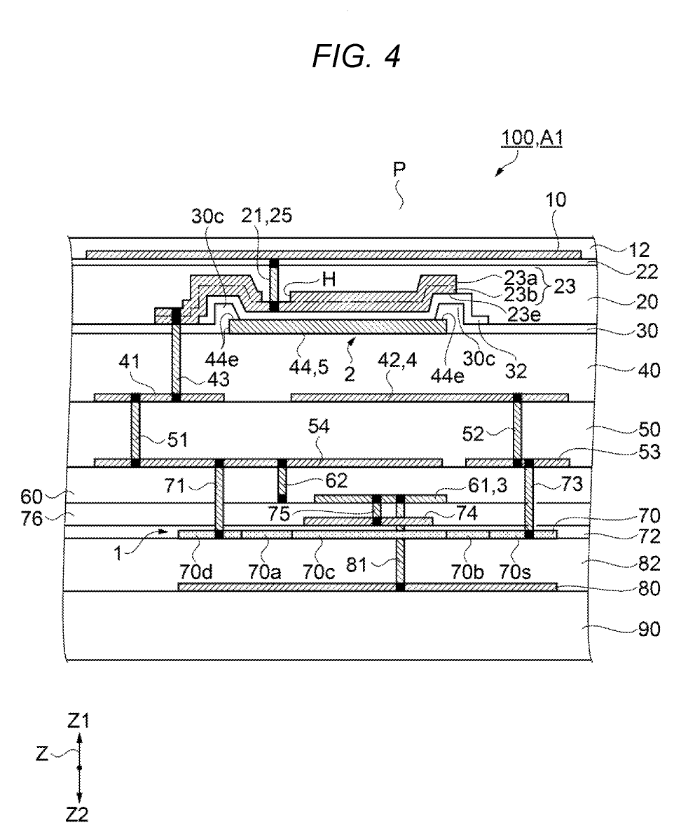

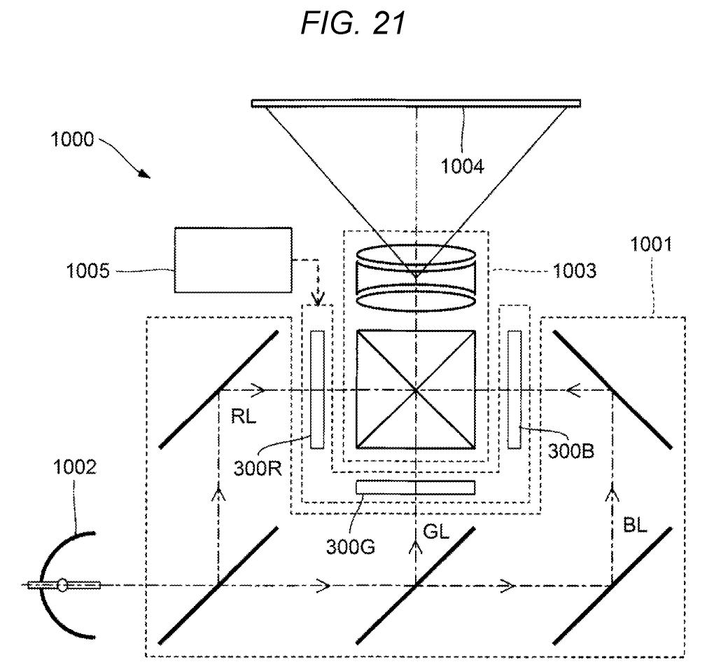

The liquid crystal device 300 (see FIG. 1) is an active drive type transmissive liquid crystal device including a thin film transistor (TFT) as a transistor 1 (see FIG. 4) for each pixel P. The liquid crystal device 300 is used as a light modulation device in, for example, a projection-type display apparatus 1000 (see FIG. 21) described later. In the present embodiment, the projection-type display apparatus 1000 is an example of an electronic apparatus.

### 1.1. Outline of Structure of Liquid Crystal Device 300

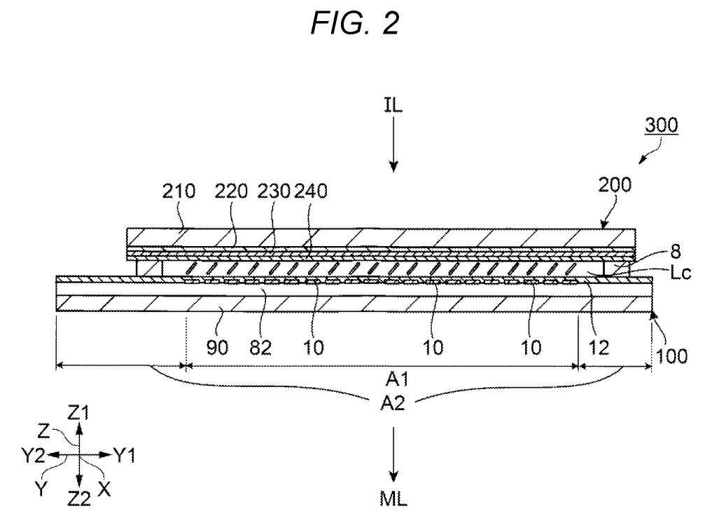

A structure of the liquid crystal device 300 according to the present embodiment will be described with reference to FIGS. 1 and 2. FIG. 1 is a plan view of the liquid crystal device 300. FIG. 2 shows a schematic cross-sectional configuration of the liquid crystal device 300 taken along a line II-II in FIG. 1.

As illustrated in FIGS. 1 and 2, the liquid crystal device 300 includes an element substrate 100 having a light transmissive property, a counter substrate 200 having a light transmissive property, a sealing member 8 disposed in a frame shape, and a liquid crystal layer Lc. Note that the term "light transmissive property" means a transmissive property with respect to visible light, and means that the transmittance for the visible light is preferably no lower than 50 %.

The liquid crystal device 300 has a display region A1, where an image is displayed, and a peripheral region A2 located on the outer periphery of the display region A1 in the plan view.

A plurality of pixels P arranged in a matrix is disposed in the display region A1. Note that the liquid crystal device 300 and the display region A1 shown in FIG. 1 each have a quadrangular shape but may each have other shapes such as a circular shape.

As illustrated in FIG. 2, the element substrate 100 and the counter substrate 200 are disposed via the liquid crystal layer Lc.

In the present embodiment, the counter substrate 200 is disposed at the light incident side of the liquid crystal layer Lc, and the element substrate 100 is disposed at the light exit side of the liquid crystal layer Lc. Incident light IL incident on the counter substrate 200 is modulated by the liquid crystal layer Lc and is output as modulated light ML from the element substrate 100.

The element substrate 100 includes a base 90, a plurality of interlayer insulating layers including an interlayer insulating layer 82, pixel electrodes 10, and an orientation film 12.

A transistor 1 (see FIG. 4), a relay layer, or a conductive layer is disposed between layers of the plurality of interlayer insulating layers. The pixel electrode 10 is disposed at the light incident side of the transistor 1.

The base 90 is a flat plate having a light transmissive property and an insulating property. The base 90 is, for example, a glass substrate or a quartz substrate.

The pixel electrodes 10 each have a light transmissive property. The pixel electrodes 10 are formed of indium tin oxide (ITO). The pixel electrodes 10 may be formed of a transparent conductive material such as indium zinc oxide (IZO) or fluorine-doped tin oxide (FTO).

The orientation film 12 has a light transmissive property and an insulating property. The orientation film 12 aligns the liquid crystal molecules of the liquid crystal layer Lc. Examples of the material of the orientation film 12 include silicon oxide (SiO₂) and polyimide.

The counter substrate 200 includes a base 210, an insulating layer 220, a common electrode 230, and an orientation film 240.

The base 210 is a flat plate having a light transmissive property and an insulating property. The base 210 is, for example, a glass substrate or a quartz substrate.

The insulating layer 220 has a light transmissive property and an insulating property. The material of the insulating layer 220 is, for example, an inorganic material such as silicon oxide.

The common electrode 230 is an electrode disposed to face the plurality of pixel electrodes 10, and is also called a counter electrode. The common electrode 230 is formed of a transparent conductive material made of, for example, ITO, IZO, or FTO. The common electrode 230 and each of the pixel electrodes 10 apply an electric field to the liquid crystal layer Lc.

The orientation film 240 has a light transmissive property and an insulating property.

The sealing member 8 is disposed between the element substrate 100 and the counter substrate 200. The sealing member 8 is made of, for example, an adhesive containing various types of curable resin such as epoxy resin. The sealing member 8 may include a gap member formed of an inorganic material such as glass.

The liquid crystal layer Lc is disposed in a region surrounded by the element substrate 100, the counter substrate 200, and the sealing member 8. The liquid crystal layer Lc is an electro-optical layer optical characteristics of which change in accordance with an electric field generated by the pixel electrode 10 and the common electrode 230. The liquid crystal layer Lc contains liquid crystal molecules having positive or negative dielectric anisotropy. The orientation of the liquid crystal molecules changes in accordance with the electric field applied to the liquid crystal layer Lc. The liquid crystal layer Lc modulates the incident light IL in accordance with the electric field applied thereto.

As illustrated in FIG. 1, a plurality of scanning line drive circuits 6, a data line drive circuit 7, and external terminals 9 are disposed in the peripheral region A2 of the element substrate 100.

The external terminals 9 are mounting terminals on which external coupling lines such as flexible printed circuits (FPCs) not shown are mounted. Various signals such as an image signal, a synchronization signal, an inspection signal, a common potential, and a power supply potential are externally supplied to the external terminals 9 via the external coupling lines.

### 1.2. Electrical Configuration of Element Substrate 100

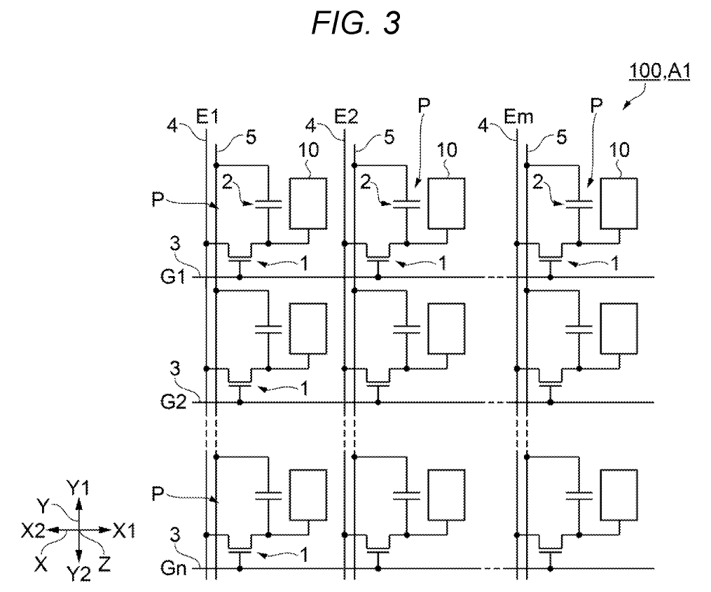

FIG. 3 is an equivalent circuit diagram showing an electrical configuration of the element substrate 100.

As illustrated in FIG. 3, a plurality of transistors 1, n scanning lines 3, m data lines 4, m capacitance lines 5, the pixel electrodes 10, and capacitive elements 2 are disposed in the display region A1 of the element substrate 100. The characters n and m are each an integer no smaller than 2.

The transistor 1 is disposed so as to correspond to each of intersections of the n scanning lines 3 and the m data lines 4. The pixel electrode 10 is electrically coupled to the drain region of the transistor 1.

The n scanning lines 3 each extend in the X1 direction, and are arranged at regular intervals in the Y1 direction. The n scanning lines 3 are each electrically coupled to the gate electrodes of the corresponding transistors 1. The n scanning lines 3 are electrically coupled to the scanning line drive circuits 6 shown in FIG. 1.

The scanning line drive circuit 6 line-sequentially supplies scanning signals G1, G2, …, and Gn to the 1-st to n-th scanning lines 3.

The m data lines 4 each extend in the Y1 direction, and are arranged at regular intervals in the X1 direction. The m data lines 4 are each electrically coupled to the source electrodes of the plurality of corresponding transistors 1. The m data lines 4 are electrically coupled to the data line drive circuit 7 shown in FIG. 1.

The data line drive circuit 7 supplies the image signals E1, E2, …, and Em to the 1-st to m-th data lines 4.

The n scanning lines 3 and the m data lines 4 are electrically insulated from each other and arranged in a grid shape in the plan view. A region surrounded by two adjacent scanning lines 3 and two adjacent data lines 4 corresponds to the pixel P.

The m capacitance lines 5 each extend in the Y1 direction, and are arranged at regular intervals in the X1 direction. The capacitance lines 5 are electrically insulated from the data lines 4 and the scanning lines 3, and are arranged at distances from these lines. A fixed potential such as the common potential or the ground potential is supplied to the capacitance lines 5 via the external terminals 9.

One electrode of the capacitive element 2 is electrically coupled to the capacitance line 5.

The other electrode of the capacitive element 2 is electrically coupled to the pixel electrode 10 and holds the potential of the image signal E1 or the like supplied to the pixel electrode 10.

### 1.3. Cross-Sectional Structure and Planar Structure of Display Region A1 of Element Substrate 100

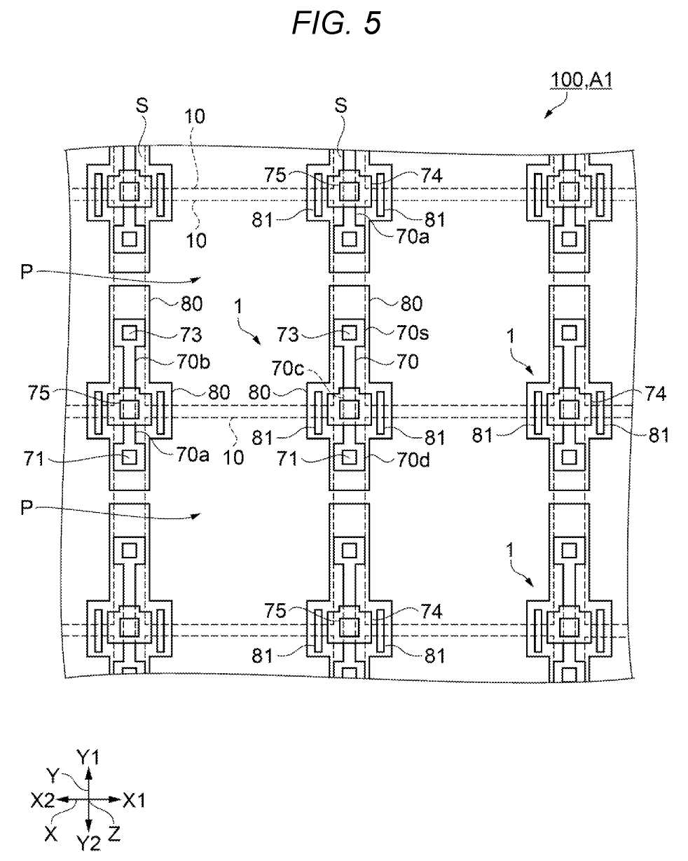

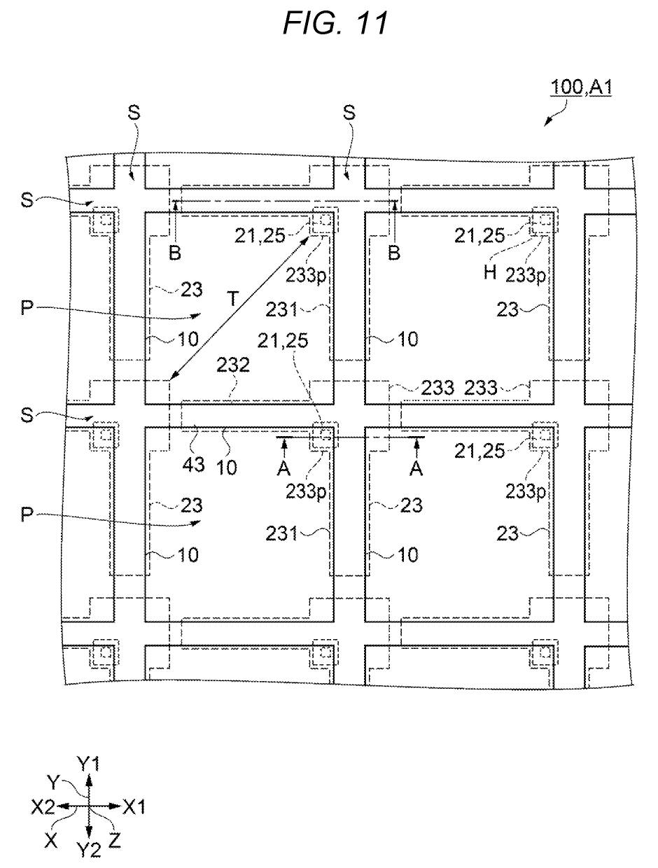

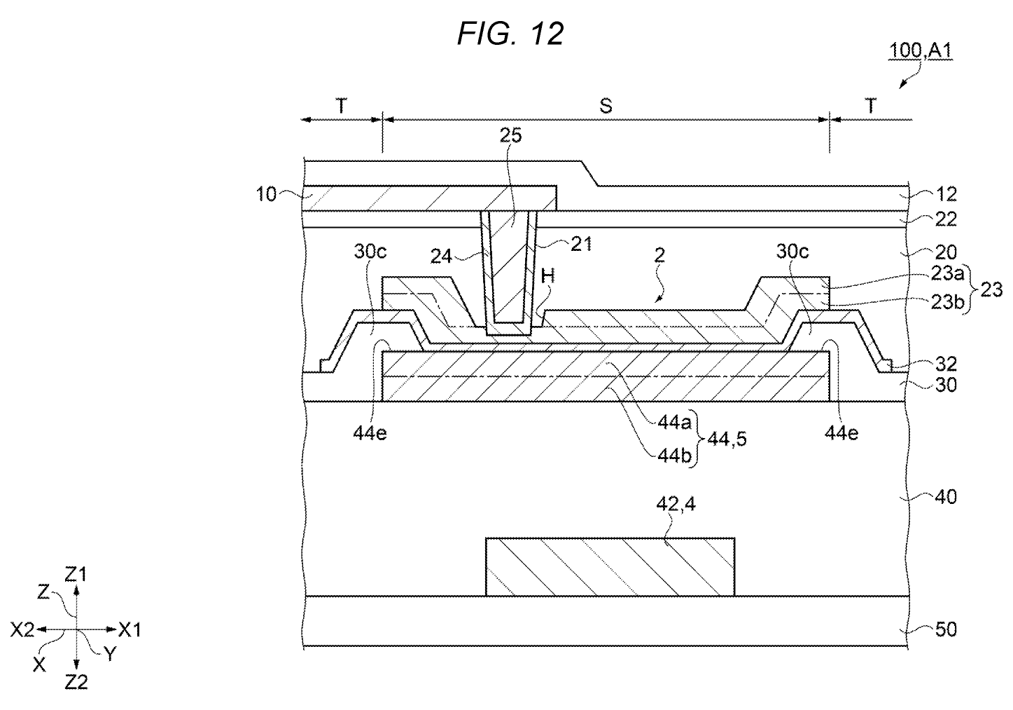

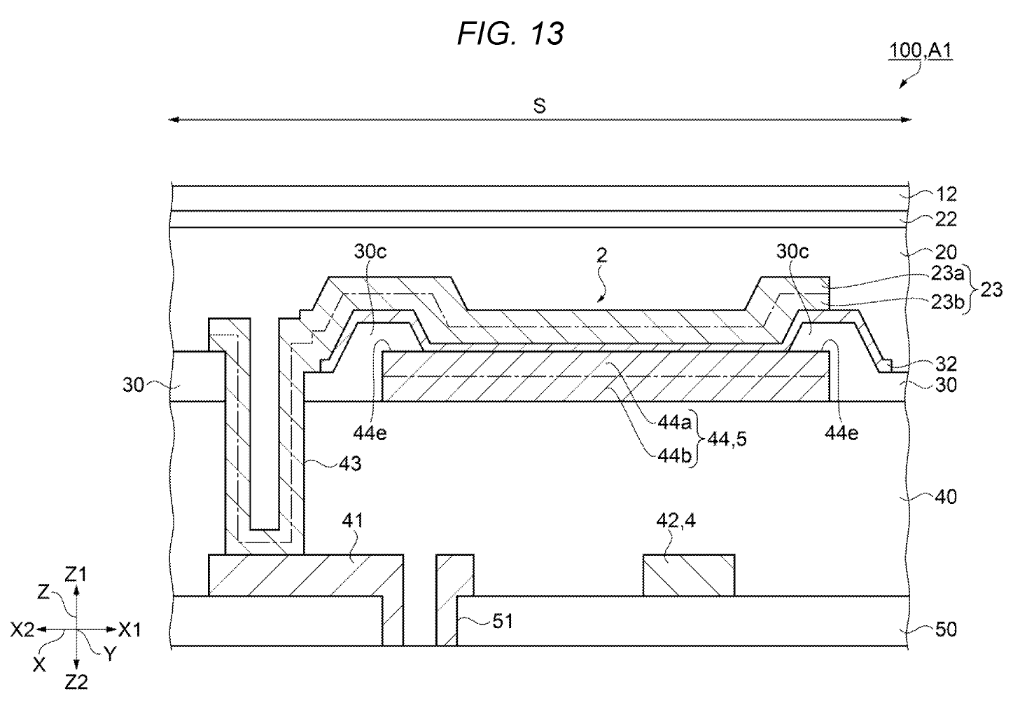

FIG. 4 is a diagram schematically illustrating a cross-sectional structure and a coupling relationship of the display region A1 of the element substrate 100, and is a cross-sectional view illustrating a stacking relationship and an electrical coupling relationship of the layers. FIGS. 5 to 11 are plan views illustrating the planar structures of principal layers. FIG. 12 is a cross-sectional view taken along a line A-A in FIG. 11. FIG. 13 is a cross-sectional view taken along a line B-B in FIG. 11.

As illustrated in FIG. 4, in the display region A1, the element substrate 100 has a cross-sectional structure in which insulating or conductive functional layers or functional films are stacked on the base 90.

FIG. 5 is a plan view illustrating a planar structure of the base 90 to an interlayer insulating layer 76. In FIG. 5, a light blocking layer 80, a semiconductor layer 70, a gate electrode 74, and contact holes 71, 73, 75, and 81 are represented by solid lines. In FIGS. 5 to 9, the position of the pixel electrode 10 is represented by a broken line in order to show a positional relationship of components in the plan view. The pixel electrode 10 has a quadrangular shape.

As illustrated in FIG. 4, the light blocking layer 80 is disposed between the base 90 and the interlayer insulating layer 82.

As illustrated in FIG. 5, the light blocking layer 80 constitutes a part of a light blocking region S of the pixel P, and is disposed so as to overlap the transistor 1 in the plan view. The transistor 1 is disposed to extend in the Y1 direction and the Y2 direction among the four pixel electrodes 10. The light blocking layer 80 has a portion extending in the Y1 direction, a portion extending in the Y2 direction, and a projecting portion that overlaps a corner portion of each of the four pixel electrodes 10.

The light blocking layer 80 is made of a conductive material having a light blocking property. As the conductive material having the light blocking property, it is possible to use metal such as tungsten (W), titanium (Ti), chromium (Cr), iron (Fe), or aluminum (Al), or a metal material such as a metal nitride or a metal silicide. Hereinafter, the conductive material having the light blocking property is substantially the same and functions as the light blocking layer. Note that the term "light blocking property" means a light blocking property with respect to the visible light, and means that the transmittance for the visible light is preferably lower than 50 %, and more preferably no higher than 10 %.

The interlayer insulating layer 82 has a light transmissive property and an insulating property. The interlayer insulating layer 82 is formed of an inorganic material such as silicon oxide (SiO₂). Hereinafter, each of the interlayer insulating layers is made of the same material as that of the interlayer insulating layer 82.

As illustrated in FIG. 4, the transistor 1 is disposed at the interlayer insulating layer 82.

The transistors 1 each include a semiconductor layer 70 having a lightly doped drain (LDD) structure, the gate electrode 74, and a gate insulating layer 72.

The semiconductor layer 70 includes a drain region 70d, an LDD region 70a, a channel region 70c, an LDD region 70b, and a source region 70s.

The channel region 70c is located in a central portion of the semiconductor layer 70. The LDD region 70b is located between the channel region 70c and the source region 70s. The LDD region 70a is located between the channel region 70c and the drain region 70d.

The semiconductor layer 70 is made of, for example, polysilicon, and a region excluding the channel region 70c is doped with an impurity for increasing conductivity. The impurity concentrations in the LDD region 70b and the LDD region 70a are lower than those in the source region 70s and the drain region 70d.

The gate electrode 74 is disposed at the semiconductor layer 70 via the gate insulating layer 72.

The gate electrode 74 overlaps the channel region 70c of the semiconductor layer 70.

The gate electrode 74 is formed using, for example, polysilicon doped with an impurity for increasing conductivity. Note that the gate electrode 74 may be formed using a material having conductivity such as metal, metal silicide, or a metal compound.

The gate insulating layer 72 is formed of silicon oxide deposited by, for example, thermal oxidation or chemical vapor deposition (CVD).

The interlayer insulating layer 76 is disposed at the transistor 1.

A conductive layer 61 is disposed at the interlayer insulating layer 76. In the present embodiment, the conductive layer 61 is the scanning line 3.

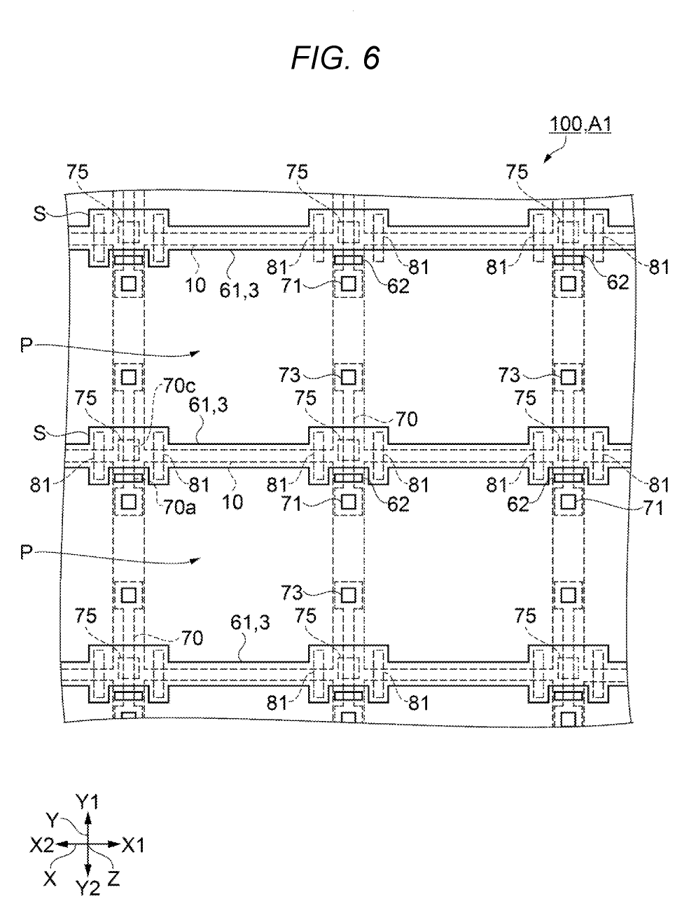

FIG. 6 is a plan view illustrating a planar structure of the conductive layer 61 disposed at the interlayer insulating layer 76, wherein the conductive layer 61, a light blocking member 62, and the contact holes 71, 73 are represented by solid lines, and the contact holes 75, 81 and the semiconductor layer 70 are represented by broken lines.

As shown in FIG. 4, the conductive layer 61 is electrically coupled to the gate electrode 74 via the contact hole 75 provided to the interlayer insulating layer 76. The conductive layer 61 is further electrically coupled to the light blocking layer 80 via the contact hole 81 provided to the interlayer insulating layers 76 and 82. The light blocking layer 80 is supplied with the scanning signal G1 or the like from the conductive layer 61, and thus functions as a back gate.

As illustrated in FIG. 6, the contact hole 81 is disposed along a side surface at the X1 direction side and a side surface at the X2 direction side of the channel region 70c and the LDD region 70a, and the channel region 70c and the LDD region 70a are shielded from light incident from the side surfaces by providing a light blocking member made of a light blocking metal such as tungsten to the contact hole 81.

The conductive layer 61 is formed of a conductive material having a light blocking property and constitutes a part of the light blocking region S of the pixel P. The conductive layer 61 extends in the X1 direction and the X2 direction so as to overlap an area between the pixel electrodes 10 adjacent to each other in the Y1 direction and the Y2 direction. The conductive layer 61 has a projecting portion overlapping a corner portion of the pixel electrode 10.

The light blocking member 62 is disposed so as to overlap the LDD region 70a in the plan view. As illustrated in FIG. 4, the light blocking member 62 is electrically coupled to a relay layer 54, and the potential of the drain region 70d is applied to the light blocking member 62 via the contact hole 71 and the relay layer 54.

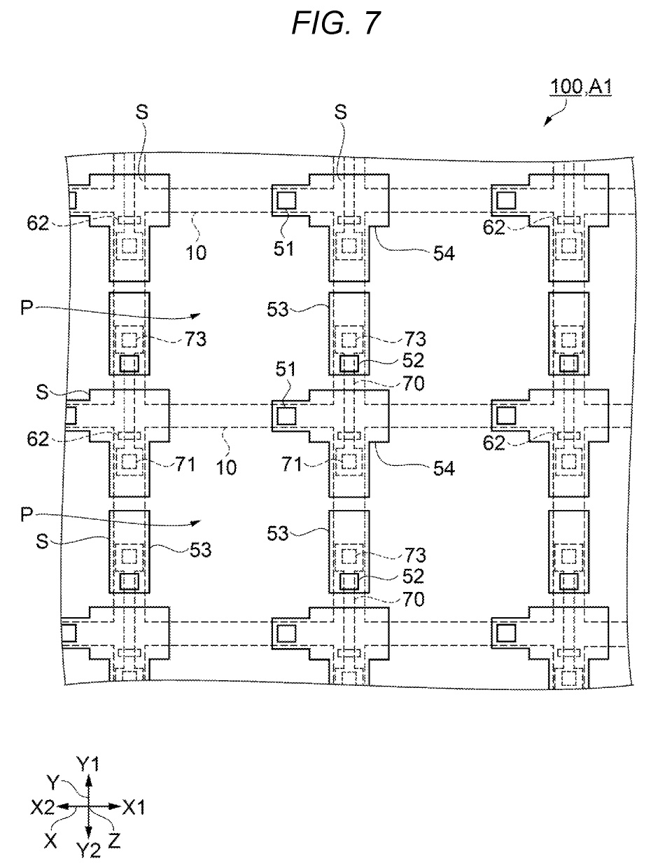

FIG. 7 is a plan view illustrating a planar structure of a relay layer 53 and the relay layer 54, wherein the relay layers 53, 54 and contact holes 51, 52 are represented by solid lines, and the contact holes 71, 73, the light blocking member 62, and the semiconductor layer 70 are represented by broken lines.

The relay layer 53 and the relay layer 54 are formed of a conductive material having a light blocking property, and constitute a part of the light blocking region S of the pixel P. The relay layer 53 and the relay layer 54 are disposed so as to overlap an area between the pixel electrodes 10 adjacent to each other in the X1 direction and the X2 direction.

The relay layer 54 is disposed at a position where the relay layer 54 overlaps corner portions of the four pixel electrodes 10, and has a projecting portion overlapping the corner portion of each of the pixel electrodes 10.

As illustrated in FIG. 4, the relay layer 54 is electrically coupled to the drain region 70d of the semiconductor layer 70 via the contact hole 71 provided to the interlayer insulating layers 60 and 76.

The relay layer 53 is electrically coupled to the source region 70s of the semiconductor layer 70 via the contact hole 73 provided to the interlayer insulating layers 60 and 76.

The interlayer insulating layer 50 is disposed at the relay layer 53 and the relay layer 54, and a relay layer 41 and a conductive layer 42 are disposed at the interlayer insulating layer 50.

In the present embodiment, the conductive layer 42 is the data line 4. The relay layer 41 and the conductive layer 42 are provided in the same layer and are each formed of a conductive material having a light blocking property.

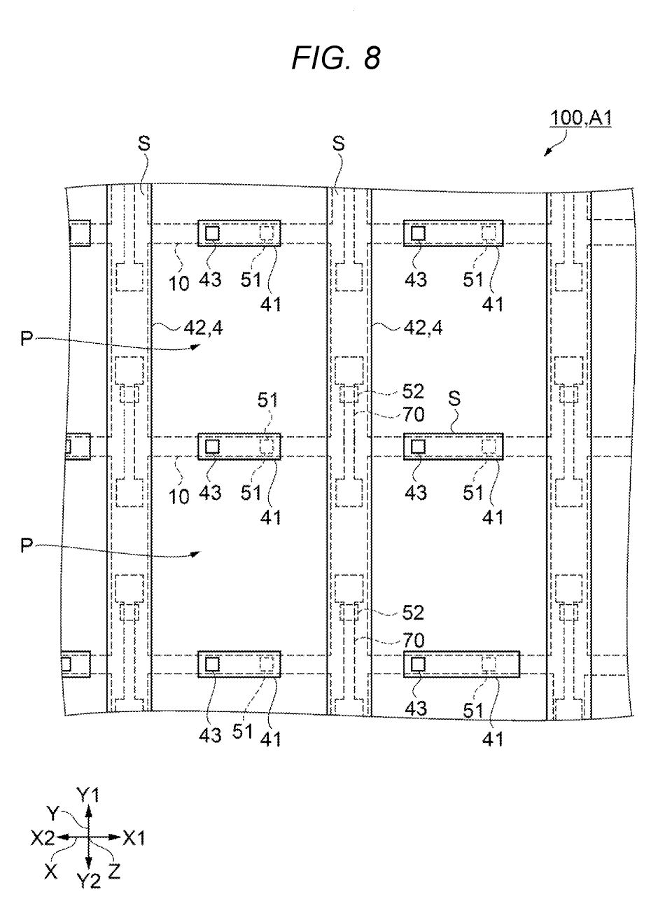

FIG. 8 is a plan view illustrating a planar structure of the relay layer 41 and the conductive layer 42, wherein the relay layer 41, the conductive layer 42, and a contact hole 43 are represented by solid lines, and the contact holes 51, 52 and the semiconductor layer 70 are represented by broken lines.

The relay layer 41 and the conductive layer 42 are formed of a conductive material having a light blocking property and constitute a part of the light blocking region S of the pixel P.

The relay layer 41 is disposed so as to overlap an area between the pixel electrodes 10 adjacent to each other in the Y1 direction and the Y2 direction.

The conductive layer 42 extends in the Y1 direction and the Y2 direction so as to overlap an area between the pixel electrodes 10 adjacent to each other in the X1 direction and the X2 direction, and is disposed so as to overlap the semiconductor layer 70.

As illustrated in FIG. 4, the relay layer 41 is electrically coupled to the relay layer 54 via the contact hole 51. The conductive layer 42 is electrically coupled to the relay layer 53 via the contact hole 52.

An interlayer insulating layer 40 is disposed at the relay layer 41, the conductive layer 42, and the interlayer insulating layer 50.

A conductive layer 44 and an interlayer insulating layer 30 are disposed at the interlayer insulating layer 40. In the present embodiment, the conductive layer 44 is the capacitance line 5.

A capacitance insulating layer 32, a conductive layer 23, and an interlayer insulating layer 20 are disposed at the conductive layer 44 and the interlayer insulating layer 30.

The conductive layer 44, the capacitance insulating layer 32, and the conductive layer 23 constitute the capacitive element 2. In the present embodiment, the conductive layer 23 is an example of a first conductive layer, and the conductive layer 44 is an example of a second conductive layer.

An end portion 44e of the conductive layer 44 is covered with an insulating member 30c in an area between the conductive layer 44 and the conductive layer 23. In other words, the insulating member 30c is disposed along an outer edge of the capacitive element 2 in the area between the conductive layer 44 and the conductive layer 23. In the present embodiment, the end portion 44e of the conductive layer 44 includes an upper surface along an outer edge of the conductive layer 44. The end portion 44e may include a side surface of the outer edge of the conductive layer 44. In the present embodiment, the insulating member 30c is a part of the interlayer insulating layer 30, but may be formed of another material or in another process.

Since the end portion 44e of the conductive layer 44 is covered with the insulating member 30c, the end portion 44e of the conductive layer 44 and an end portion 23e of the conductive layer 23 are separated from each other by the insulating member 30c. Therefore, it is possible to achieve a configuration in which the conductive layer 44 and the conductive layer 23 are less likely to be short-circuited. In the present embodiment, the end portion 23e of the conductive layer 23 includes a lower surface along an outer edge of the conductive layer 23. The end portion 23e may include a side surface of the outer edge of the conductive layer 23.

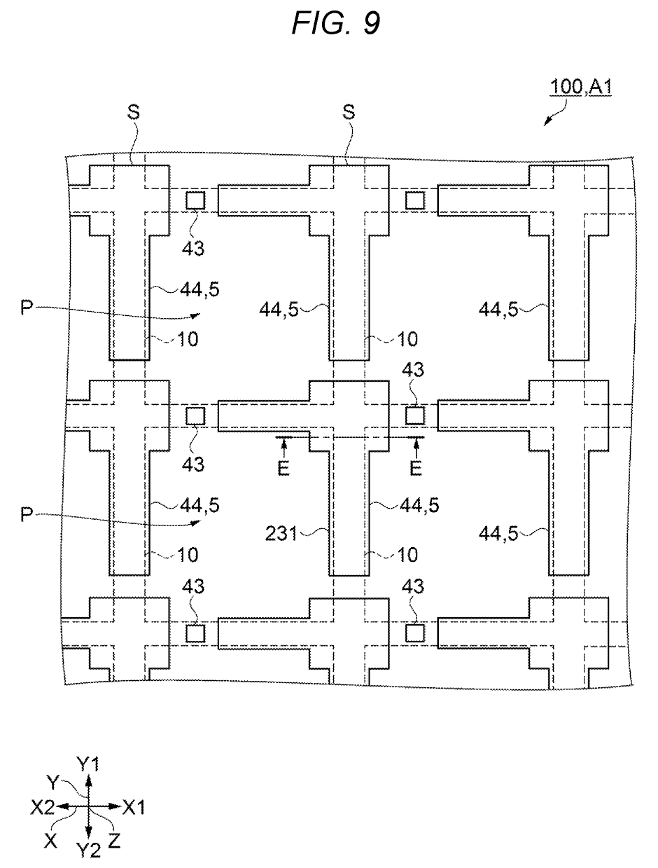

FIG. 9 is a plan view illustrating a planar structure of the conductive layer 44 and the contact hole 43, wherein the conductive layer 44 and the contact hole 43 are represented by solid lines.

The conductive layer 44 is formed of a conductive material having a light blocking property and constitutes a part of the light blocking region S of the pixel P.

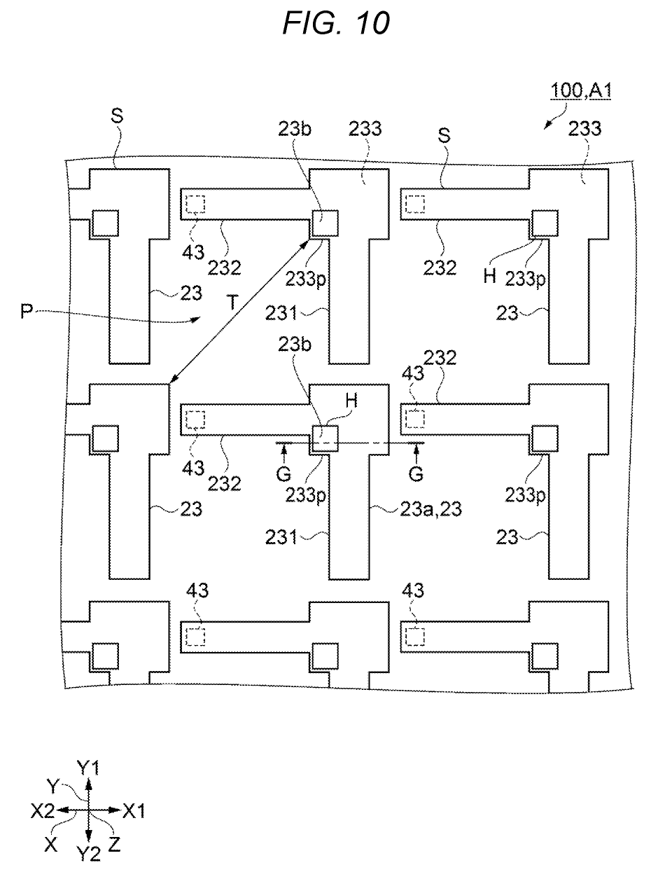

FIG. 10 is a plan view illustrating a planar structure of the conductive layer 23, the contact hole 43, and an opening H, wherein the conductive layer 23 and the opening H are represented by solid lines, and the contact hole 43 is represented by a broken line.

The conductive layer 23 is electrically coupled to the relay layer 41 via the contact hole 43. The conductive layer 23 is formed of a conductive material having a light blocking property and constitutes a part of the light blocking region S of the pixel P.

The conductive layer 23 has an inverted L shape in the plan view.

The conductive layer 23 includes a main body portion 233 having a projecting portion 233p projecting to a corner portion of an opening region T of the pixel P, an extending portion 231 extending in the Y2 direction from the main body portion 233, and an extending portion 232 extending in the X2 direction from the main body portion 233.

The corner portion of the opening region T of the pixel P is a portion adjacent to a portion where a grid of the light blocking region S disposed in a grid shape forms an intersection. The opening region T of the pixel P can be reworded as a light transmissive region. In the present embodiment, the Y2 direction is an example of a first direction, the extending portion 231 is an example of a first extending portion, the X2 direction is an example of a second direction, and the extending portion 232 is an example of a second extending portion.

As illustrated in FIG. 4, the conductive layer 23 is a light blocking layer located closest to the pixel electrode 10, and has a function as a light reflection layer. The conductive layer 23 includes a conductive film 23a made of a material having light reflectivity, and a conductive film 23b made of a material lower in optical reflectance than the conductive film 23a and disposed closer to the transistor 1 than the conductive film 23a. The conductive film 23a contains aluminum, and the conductive film 23b contains titanium nitride (TiN).

The conductive film 23a has high optical reflectance and reflects about 90 % of the light with which the conductive film 23a is irradiated. In other words, the conductive film 23a can reduce the light absorbed by the conductive film 23a out of the light applied thereto to about 10 %. Therefore, according to the present embodiment, it is possible to suppress a rise in temperature of the liquid crystal device 300. In the present embodiment, the conductive film 23a is an example of a first film, and the conductive film 23b is an example of a second film.

The conductive film 23a of the conductive layer 23 has the opening H. The opening H exposes the conductive film 23b at a bottom of the opening H. A contact hole 21 is disposed at a position at a distance from an edge of the opening H inside the opening H. That is, the contact hole 21 is disposed at a position not in contact with the conductive film 23a.

As shown in FIG. 10, the opening H is disposed in a region which is provided to the main body portion 233 of the conductive layer 23 and extends from the projecting portion 233p to the inside of the main body portion 233.

FIG. 11 is a plan view illustrating a planar structure of the pixel electrode 10, the conductive layer 23, the contact hole 21, and a plug 25, wherein the pixel electrode 10 is represented by a solid line, and the conductive layer 23, the contact hole 21, and the plug 25 are represented by broken lines.

The contact hole 21 is disposed inside the opening H at a position separated from the edge of the opening H in the plan view.

As illustrated in FIG. 4, by disposing the capacitance line 5 between the conductive layer 23 and the data line 4, the conductive layer 23 and the data line 4 are shielded from each other by the capacitance line 5, and electrical coupling between the conductive layer 23 and the data line 4 is suppressed. Therefore, it is possible to prevent the image signal E1 and so on of other pixels P supplied to the data lines 4 from being applied as noise to the conductive layer 23.

The interlayer insulating layer 20 and a protective layer 22 are disposed at the conductive layer 23. The protective layer 22 is made of an inorganic material having a light transmissive property and a hygroscopic property such as borosilicate glass (BSG). The protective layer 22 may be omitted. The pixel electrode 10 is disposed at the protective layer 22.

The pixel electrode 10 is electrically coupled to the conductive layer 23 via the contact hole 21 provided to the interlayer insulating layer 20 and the protective layer 22. The plug 25 is disposed in the contact hole 21. The contact hole 21 and the plug 25 constitute a pixel contact. The pixel contact is a component that electrically couples the pixel electrode 10 and the conductive layer 23 immediately below the pixel electrode 10.

### 1.4. Capacitive Element 2 and Pixel Contact

FIG. 12 is a cross-sectional view taken along a line A-A in FIG. 11, and illustrates a cross-sectional configuration of the capacitive element 2 and the pixel contact. FIG. 13 is a cross-sectional view taken along a line B-B in FIG. 11 and illustrates a cross-sectional configuration of the capacitive element 2.

As illustrated in FIG. 12, the pixel contact electrically couples the pixel electrode 10 and the conductive layer 23. In the present embodiment, the pixel contact includes the contact hole 21 and the plug 25. The pixel contact may be formed of the contact hole 21 and the pixel electrode 10 deposited in the contact hole 21.

The contact hole 21 penetrates the interlayer insulating layer 20 and the protective layer 22, reaches the conductive film 23b containing titanium nitride in the opening H provided to the conductive film 23a containing aluminum, and exposes the conductive film 23b at a bottom of the contact hole 21. The contact hole 21 is disposed in the opening H at a position separated from the edge of the opening H of the conductive film 23a. That is, the contact hole 21 is disposed at a position not overlapping the conductive film 23a in the plan view so as not to be in contact with the conductive film 23a.

Since the contact hole 21 is disposed at a position not overlapping the conductive film 23a, etching residue caused by aluminum is not generated when the contact hole 21 is formed. That is, in the present embodiment, there is no need to remove the etching residue. Therefore, in the present embodiment, a possibility that the conductive film 23a containing aluminum is side-etched when removing the etching residue to increase the risk of reliability in the pixel contact does not arise.

The plug 25 is disposed in the contact hole 21. The plug 25 contains tungsten. Tungsten is a material that has excellent heat resistance and is easily embedded in a contact hole having a high aspect ratio. Therefore, tungsten can completely fill the elongated contact hole 21. Therefore, the reliability of the plug 25 as a coupling member can be improved.

A barrier film 24 is disposed between the plug 25 and the contact hole 21. The barrier film 24 is formed of tungsten nitride (WN) or titanium nitride. Tungsten nitride or titanium nitride has excellent adhesion to the interlayer insulating layer 20. Therefore, the barrier film 24 can suppress separation of the plug 25 and improve the reliability of the plug 25.

As illustrated in FIG. 13, the conductive layer 23 is deposited in the contact hole 43 and is electrically coupled to the relay layer 41 at the bottom of the contact hole 43.

### 1.5. Method Of Manufacturing Capacitive Element 2 and Pixel Contact

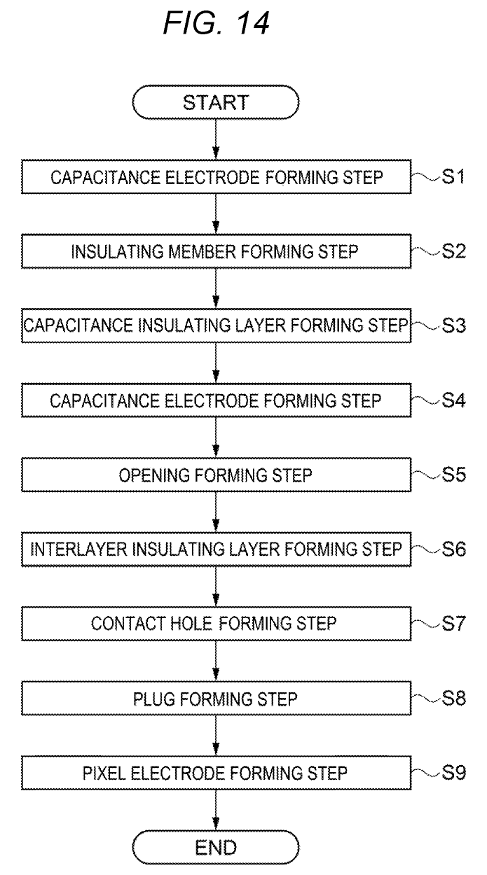

Then, a method of manufacturing the capacitive element 2 and the pixel contact will be described with reference to FIGS. 14 to 20.

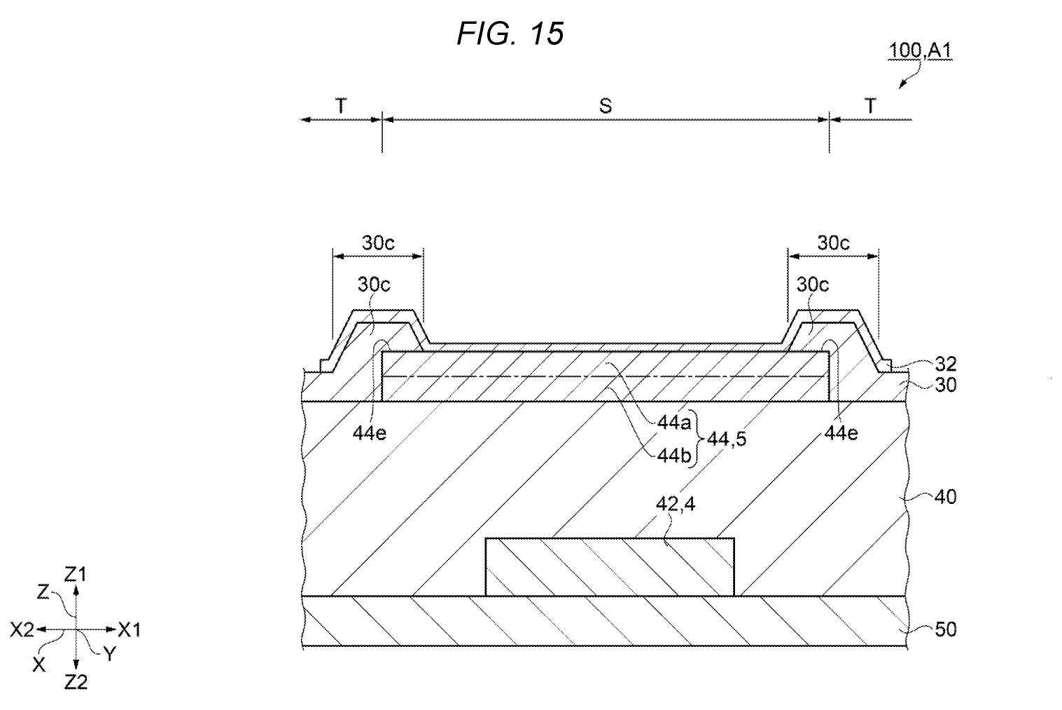

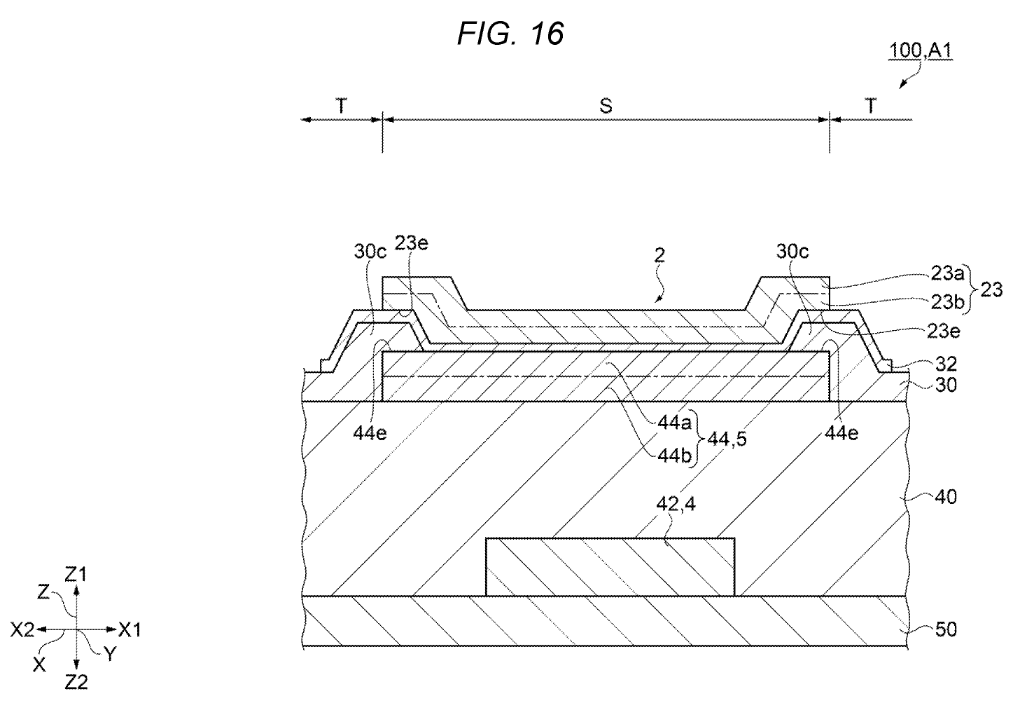

FIG. 14 is a flowchart illustrating the method of manufacturing the capacitive element 2 and the pixel contact. FIGS. 15 to 20 are cross-sectional views or plan views illustrating an aspect of a manufacturing process of the capacitive element 2 and the pixel contact. FIG. 15 corresponds to a cross section taken along a line E-E in FIG. 9. FIGS. 16 to 19 correspond to a cross section taken along a line G-G in FIG. 10.

As illustrated in FIG. 14, the method for manufacturing the capacitive element 2 and the pixel contact includes a capacitance electrode forming step S1, an insulating member forming step S2, a capacitance insulating layer forming step S3, a capacitance electrode forming step S4, an opening forming step S5, an interlayer insulating layer forming step S6, a contact hole forming step S7, a plug forming step S8, and a pixel electrode forming step S9.

In the capacitance electrode forming step S1, as illustrated in FIG. 15, the conductive layer 44 as a capacitance electrode of the capacitive element 2 is formed. The conductive layer 44 includes a conductive film 44a containing TiN and a conductive film 44b containing aluminum. The capacitance electrode forming step S1 includes a step of depositing the conductive film 44b and the conductive film 44a in this order at the interlayer insulating layer 40, and a step of patterning, by photolithography, the conductive film 44b and the conductive film 44a thus deposited.

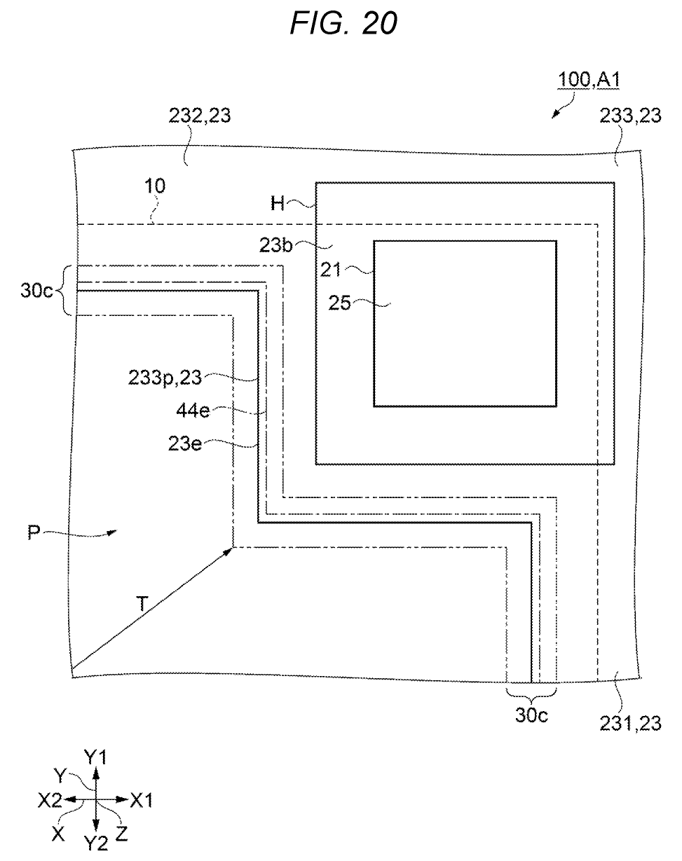

In the insulating member forming step S2, as shown in FIG. 15, the insulating member 30c is formed at the end portion 44e of the conductive layer 44. The insulating member 30c can be formed by a step of forming the interlayer insulating layer 30 on the conductive layer 44 and a step of removing a part of the interlayer insulating layer 30 on the conductive layer 44 by photolithography. As illustrated in FIG. 20, the insulating member 30c is formed so as to overlap the end portion 44e of the conductive layer 44 represented by a dashed-dotted line and the end portion 23e of the conductive layer 23 represented by a solid line in the plan view.

In the capacitance insulating layer forming step S3, as illustrated in FIG. 15, the capacitance insulating layer 32 is formed. The capacitance insulating layer 32 is formed so as to cover the insulating member 30c in the end portion 44e of the conductive layer 44.

In the capacitance electrode forming step S4, as illustrated in FIG. 16, the conductive layer 23 as the capacitance electrode of the capacitive element 2 is formed. The capacitance electrode forming step S4 includes a step of depositing the conductive film 23b and the conductive film 23a in this order on the capacitance insulating layer 32, and a step of patterning, by photolithography, the conductive film 23b and the conductive film 23a thus deposited.

The conductive film 23a of the conductive layer 23 is disposed at a position where a part thereof overlaps the insulating member 30c. Specifically, the end portion 23e of the conductive layer 23 overlaps the insulating member 30c except the vicinity of the contact hole 43.

As illustrated in FIG. 20, by the end portion 23e of the conductive layer 23 overlapping the insulating member 30c in the plan view, the conductive layer 23 and the conductive layer 44 are separated from each other in accordance with the insulating member 30c. Therefore, it is possible to achieve a configuration in which the conductive layer 23 and the conductive layer 44 are unlikely to be short-circuited.

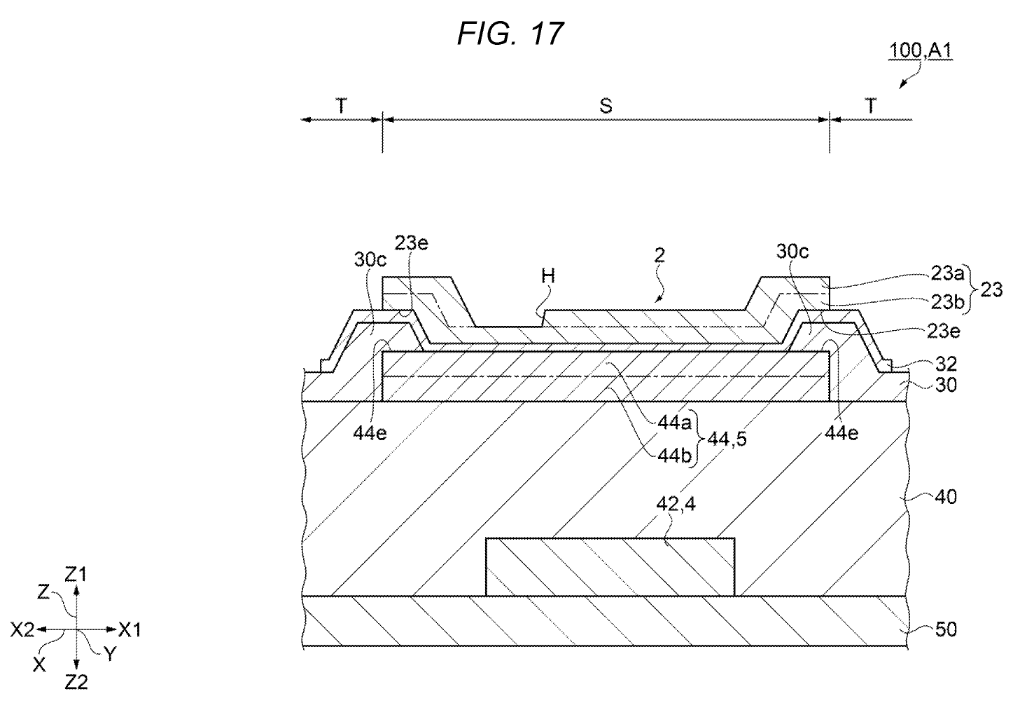

In the opening forming step S5, as shown in FIG. 17, the opening H that exposes the conductive film 23b is formed in the conductive film 23a of the conductive layer 23. The opening forming step S5 includes a step of removing the conductive film 23a on the conductive film 23b by half-etching the conductive layer 23 at a position where the opening H is to be formed by photolithography.

As illustrated in FIG. 20, the opening H is disposed in a region extending from the projecting portion 233p of the main body portion 233 to the inside of the main body portion 233. By disposing the opening H in a region extending from the projecting portion 233p to the inside of the main body portion 233, the projection of the projecting portion 233p to the opening region T can be suppressed. Therefore, the aperture ratio can be increased, and bright display can be performed.

The opening H is not disposed at a position overlapping the insulating member 30c in the plan view. Although a step due to the insulating member 30c is formed at a position overlapping the insulating member 30c, since the opening H is disposed at a position not overlapping the insulating member 30c in the plan view, the opening H can be formed with high accuracy.

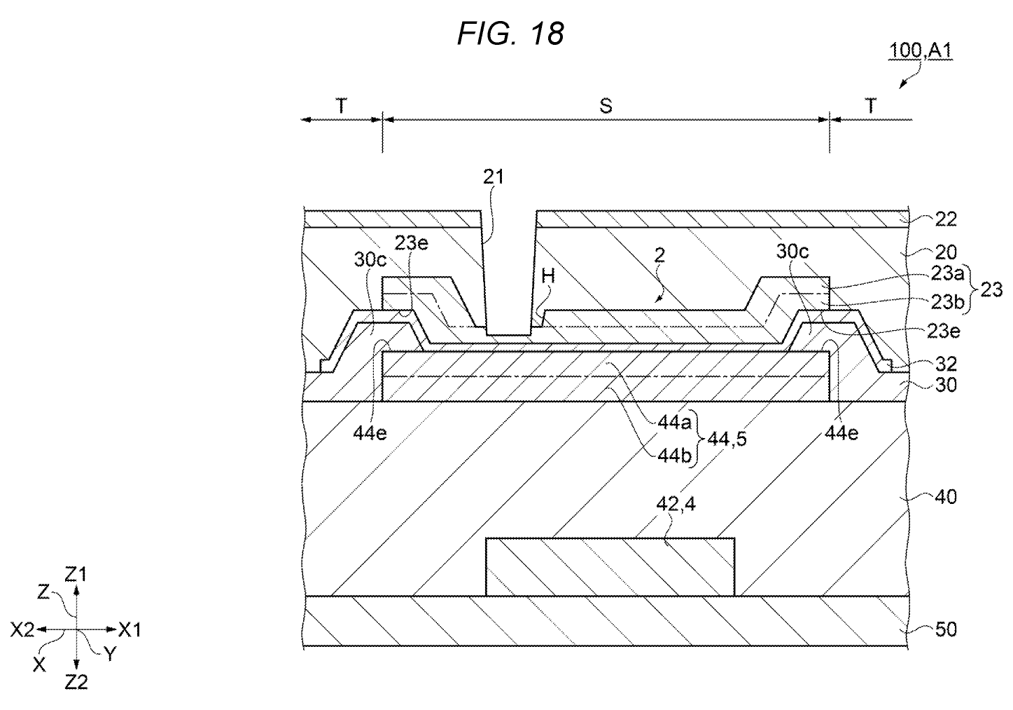

In the interlayer insulating layer forming step S6, as shown in FIG. 18, the interlayer insulating layer 20 is formed at the conductive layer 23. In the present embodiment, the protective layer 22 is disposed at the interlayer insulating layer 20.

In the contact hole forming step S7, the contact hole 21 exposing the conductive film 23b is formed in the interlayer insulating layer 20 and the protective layer 22.

As shown in FIG. 20, the contact hole 21 is disposed at a position not overlapping the insulating member 30c in the plan view. In the end portion 23e of the conductive layer 23, the step due to the insulating member 30c is formed, but in the present embodiment, since the contact hole 21 is disposed at a position not overlapping the insulating member 30c, the contact hole 21 can be formed with high accuracy.

As shown in FIG. 20, the contact hole 21 is disposed inside the opening H at a position separated from four sides of the edge of the opening H. Therefore, when the contact hole 21 is formed, the etching residue caused by aluminum is not generated.

In the present embodiment, since the etching residue caused by aluminum is not generated, there is no need to remove the etching residue. Therefore, a possibility that the conductive film 23a containing aluminum is side-etched when removing the etching residue to increase the risk of reliability in the pixel contact does not arise.

Here, the etching residue caused by aluminum is aluminum fluoride (AlFx). When the contact hole 21 is formed in the conductive film 23a, since aluminum fluoride is formed by an etching gas containing a fluorine (F) component used when forming the contact hole 21, an AlFx removal step of removing the aluminum fluoride is required. In the AlFx removal step, the conductive film 23a containing aluminum is side-etched by the etching gas containing Cl (chlorine), and there arises a concern that the risk of reliability of the pixel contact increases.

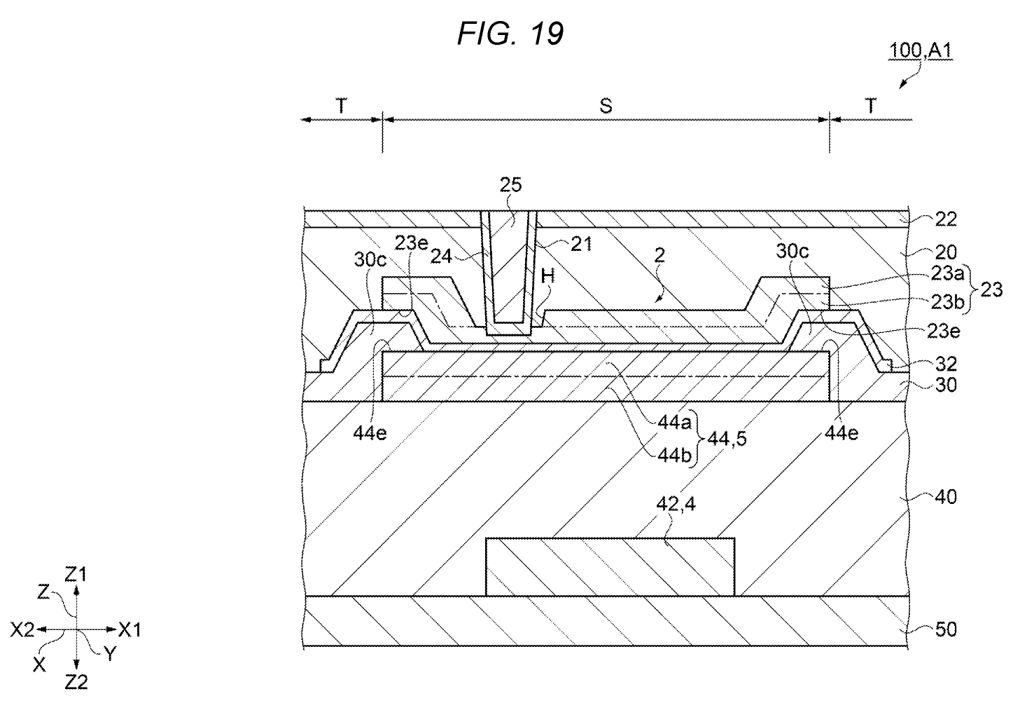

In the plug forming step S8, as shown in FIG. 19, the plug 25 is formed in the contact hole 21. In the present embodiment, the barrier film 24 is disposed between the plug 25 and the contact hole 21.

In the pixel electrode forming step S9, as illustrated in FIG. 12, the pixel electrode 10 is formed for each of the pixels P. As illustrated in FIG. 20, the pixel electrode 10 is disposed so as to overlap the opening H and the contact hole 21 in the plan view. The pixel electrode 10 is not required to overlap a part of the opening H at a portion not overlapping the contact hole 21 in the plan view.

After the pixel electrode 10 is formed, the orientation film 12 is formed.

As described above, according to the liquid crystal device 300 as the electro-optical device of the present embodiment, the following advantages can be obtained.

The liquid crystal device 300 of the present embodiment includes the transistor 1, the pixel electrode 10 disposed at the light incident side of the transistor 1, and the conductive layer 23 as the first conductive layer including, in the layer between the transistor 1 and the pixel electrode 10, the conductive film 23a as the first film formed of a material having light reflectivity, and the conductive film 23b as a second film that is formed of a material lower in optical reflectance than the conductive film 23a and is disposed closer to the transistor 1 than the conductive film 23a, wherein the conductive layer 23 includes the main body portion 233 having a projecting portion 233p projecting to the corner portion of the opening region T of the pixel P, the extending portion 231 as a first extending portion extending from the main body portion 233 along the Y2 direction as the first direction, and the extending portion 232 as a second extending portion extending from the main body portion 233 along the X2 direction as the second direction crossing the Y2 direction, and in at least the projecting portion 233p of the main body portion 233 of the conductive layer 23, the conductive film 23a of the conductive layer 23 has the opening H, and the conductive film 23b of the conductive layer 23 is electrically coupled to the pixel electrode 10 via the contact hole 21 disposed inside the opening H of the conductive film 23a at a position separated from the edge of the opening H in the plan view.

As described above, in the liquid crystal device 300 of the present embodiment, the conductive layer 23 includes the conductive film 23a formed of a material having light reflectivity, and the conductive layer 23 includes the main body portion 233, the extending portion 231 extending from the main body portion 233 along the Y2 direction, and the extending portion 232 extending from the main body portion 233 along the X2 direction. Therefore, most of the light with which the pixel P is irradiated is reflected by the conductive film 23a. Therefore, it is possible to suppress the rise in temperature of the liquid crystal device 300.

Further, the pixel electrode 10 and the conductive film 23b are electrically coupled to each other via the contact hole 21 disposed inside the opening H of the conductive film 23a at the position separated from the edge of the opening H. Therefore, the etching residue due to the material having light reflectivity is not generated when forming the contact hole 21, and thus a step of removing the etching residue is unnecessary. When the step of removing the etching residue is performed, the conductive film 23a containing the material having light reflectivity is side-etched, and the risk of reliability occurs in the pixel contact. However, according to the present embodiment, since the step of removing the etching residue is unnecessary, the risk of reliability does not occur in the pixel contact. Therefore, according to the present embodiment, it is possible to realize the liquid crystal device 300 having high reliability.

In the liquid crystal device 300 of the present embodiment, the opening H of the conductive film 23a is disposed in a region extending from the projecting portion 233p of the main body portion 233 to the inside of the main body portion 233 in the plan view.

As described above, by disposing the opening H in the region extending from the projecting portion 233p to the inside of the main body portion 233, the area of the projecting portion 233p projecting to the opening region T can be suppressed. Therefore, it is possible to suppress the influence on the opening region T, that is, the reduction in an opening region ratio of the pixel P, and it is possible to realize the liquid crystal device 300 capable of performing bright display.

The liquid crystal device 300 of the present embodiment includes the capacitive element 2 including the conductive layer 23 and the conductive layer 44 disposed so as to face the conductive layer 23, and the insulating member 30c disposed so as to cover the end portion 44e of the conductive layer 44 between the conductive layer 23 and the conductive layer 44, wherein the contact hole 21 is disposed at a position not overlapping the insulating member 30c in the plan view.

In the end portion 23e of the conductive layer 23, the step due to the insulating member 30c is formed, but in the present embodiment, since the contact hole 21 is disposed at a position not overlapping the insulating member 30c, the contact hole 21 can be formed with high accuracy.

In the liquid crystal device 300 of the present embodiment, the insulating member 30c is disposed along the end portion 23e of the projecting portion 233p in the plan view, the conductive film 23a of the conductive layer 23 is disposed at a position where a part thereof overlaps the insulating member 30c, and the opening H of the conductive film 23a is not disposed at a position where the opening H overlaps the insulating member 30c.

Since the end portion 23e of the conductive film 23a of the conductive layer 23 overlaps the insulating member 30c in the plan view, the end portion 23e of the conductive layer 23 and the conductive layer 44 are separated in accordance with the insulating member 30c. Therefore, it is possible to achieve a configuration in which the conductive layer 23 and the conductive layer 44 are unlikely to be short-circuited.

Furthermore, the opening H of the conductive film 23a is not disposed at a position overlapping the insulating member 30c in the plan view. Although a step due to the insulating member 30c is formed at a position overlapping the insulating member 30c, since the opening H is disposed at a position not overlapping the insulating member 30c in the plan view, the opening H can be formed with high accuracy.

In the liquid crystal device 300 of the present embodiment, the conductive film 23a contains aluminum, and the conductive film 23b contains titanium nitride.

The conductive film 23a containing aluminum disposed at the light incident side is a high reflection film, and the conductive film 23b containing titanium nitride disposed at the transistor 1 side is a low reflection film. Therefore, the liquid crystal device 300 can suppress the absorption of light with the conductive film 23a containing aluminum to thereby suppress the rise in temperature of the liquid crystal device 300, and can suppress the generation of stray light with the conductive film 23b containing titanium nitride to thereby suppress the deterioration of display quality.

The liquid crystal device 300 of the present embodiment includes the plug 25 as a coupling member disposed inside the contact hole 21.

As described above, by providing the plug 25 in the contact hole 21, the aspect ratio of the contact hole 21 can be made higher, in other words, the diameter of the contact hole 21 can be made smaller compared to when depositing the pixel electrode 10 in the contact hole 21. Therefore, the area of the opening H can be reduced, and thus the area of the projecting portion 233p projecting to the opening region T can be suppressed. Therefore, it is possible to suppress the influence on the opening region T, that is, the reduction in an opening region ratio of the pixel P, and it is possible to realize the liquid crystal device 300 capable of performing bright display.

### 2. Embodiment 2

FIG. 21 is a schematic diagram showing an example of an electronic apparatus, and is a schematic diagram showing a schematic configuration of a projection-type display apparatus 1000 as the electronic apparatus.

The projection-type display apparatus 1000 is, for example, a three-plate projector including three liquid crystal devices 300 described above. A liquid crystal device 300R corresponds to a red display color, a liquid crystal device 300G corresponds to a green display color, and a liquid crystal device 300B corresponds to a blue display color. A controller 1005 includes, for example, a processor and a memory, and controls operations of the liquid crystal devices 300R, 300G, and 300B.

An illumination optical system 1001 supplies red light RL, green light GL, and blue light BL out of the light emitted from an illumination device 1002 as a light source to the liquid crystal device 300R, the liquid crystal device 300G, and the liquid crystal device 300B, respectively. The liquid crystal devices 300R, 300G, and 300B function as light modulation devices that modulate the colored lights RL, GL, and BL incident from the illumination optical system 1001, respectively, in accordance with an image to be displayed.

A projection optical system 1003 combines light output from the liquid crystal device 300R, light output from the liquid crystal device 300G, and light output from the liquid crystal device 300B with each other, and projects the combined light onto a screen 1004.

As described above, the projection-type display apparatus 1000 as the electronic apparatus of the present embodiment includes the liquid crystal devices 300 described above.

Therefore, by adopting the liquid crystal device 300 in which the rise in temperature is suppressed, it is possible to improve the performance of the projection-type display apparatus 1000.

Note that the electronic apparatus is not limited to the three-plate projector presented by way of example. For example, the electronic apparatus may be a single-plate projector, a two-plate projector, or a projector including four or more liquid crystal devices 300. In addition, the electronic apparatus may be a smartphone, a personal digital assistant (PDA), a camera, a television set, a car navigation device, a personal computer, a display, electronic paper, a calculator, a video phone, a point of sale (POS) system, a printer, a scanner, a copier, a video player, an apparatus including a touch panel, and so on.

Although the preferred embodiment is described hereinabove, the present disclosure is not limited to the embodiment described above. In addition, the configuration of each element in the present disclosure can be replaced with any configuration that exhibits substantially the same function as that of the embodiment described above, and can be added with any configuration.

What is claimed is:

1. An electro-optical device, comprising:
a transistor;
a pixel electrode disposed at a light incident side of the transistor; and
a first conductive layer including, in a layer between the transistor and the pixel electrode, a first film formed of a material having light reflectivity, and a second film formed of a material lower in optical reflectance than the first film and disposed closer to the transistor than the first film, wherein
the first conductive layer includes a main body portion having a projecting portion projecting to a corner portion of an opening region of a pixel, a first extending portion extending from the main body portion along a first direction, and a second extending portion extending from the main body portion along a second direction crossing the first direction, and
in at least the projecting portion of the main body portion of the first conductive layer, the first film of the first conductive layer has an opening, and the second film of the first conductive layer is electrically coupled to the pixel electrode via a contact hole disposed inside the opening of the first film at a position separated from an edge of the opening in a plan view.

2. The electro-optical device according to claim 1, wherein
the opening of the first film is disposed in a region extending from the projecting portion of the main body portion to an inside of the main body portion in the plan view.

3. The electro-optical device according to claim 1, further comprising:
a capacitive element including the first conductive layer and a second conductive layer disposed so as to face the first conductive layer; and
an insulating member disposed so as to cover an end portion of the second conductive layer between the first conductive layer and the second conductive layer, wherein
the contact hole is disposed at a position not overlapping the insulating member in the plan view.

4. The electro-optical device according to claim 3, wherein
the insulating member is disposed along an end portion of the projecting portion in the plan view,
the first film of the first conductive layer is disposed at a position where the first film partially overlaps the insulating member, and
the opening of the first film is not disposed at a position overlapping the insulating member.

5. The electro-optical device according to claim 1, wherein
the first film contains aluminum, and
the second film contains titanium nitride.

6. The electro-optical device according to claim 1, further comprising:
a coupling member disposed in the contact hole.

7. An electronic apparatus, comprising
the electro-optical device according to claim 1.
